(19) United States
(12) Patent Application Publication
(10) Pub. No.: US 2002/0063903 A1
(43) Pub. Date: May 30, 2002

(54) Method for checking the use of a system for transmitting information submitted in the form of matrix codes

(76) Inventor: Patrice Claviez-Homberg, Bois-Colombes (FR)

Correspondence Address: WILLIAM ANTHONY DRUCKER, Attorney At Law, 1299 Pennsylvania Avenue, N.W., Washington, DC, 20004-2400, US

(21) Appl. No.: 09/766,669

(22) Filed: Jan. 23, 2001

(30) Foreign Application Priority Data
Nov. 24, 2000 (FR) 00 15458

(51) Int. Cl. H04N 1/00

(52) U.S. Cl. 358/403; 358/407

(57) ABSTRACT

The method of the invention uses a computer linked to a data base containing identification and addressing data of addressees. It consists of allocating to each user an electronic circuit able to be connected to the computer and including a memory accessible on reading and writing containing information relating to an access code the operator is to transmit to the computer so as to be able to use the method and with a credit allocated to the user, said credit being automatically decremented by the computer at the time of each use according to parameters relating to said use.

### FIELD OF THE INVENTION

The present invention concerns the management and control of the transmission of documents between a transmitter and a multiplicity of addressees.

### BACKGROUND OF THE INVENTION

It is applicable in particular, but not exclusively, to the automation of the transmission of one or several documents to a multiplicity of addressees, and the processing of the replies returned by said addressees.

These operations are carried out, for example, to conduct inquiries or polls so as to draw up the profile of a customer.

Generally speaking, it is known that it is difficult to automate the processing of printed documents sent by mail or fax using mechanical or data processing means. In fact, in order to be automated, this processing requires an automatic data entry of the information featured on the printed documents.

Now up until now, the systems for recognizing printed characters do not guarantee a 100% recognition of the characters read and requires manual intervention when an unrecognized character is detected.

Thus, they cannot be used to automatically process large amounts of mail.

### SUMMARY OF THE INVENTION

In the French patent No 97 04651 filed on Apr. 11, 1997, the Applicant had already put forward a method for the transmission of documents between a data processing system and a plurality of addressees, these documents comprising at least one portion each addressee is to send back in his response to the system.

This system includes a computer linked to a data base containing the identification and addressing information of the addressees and programmed so as to enable the following operations to be carried out:

for each addressee, the setting up of an identification information sequence including the identification data of the addressee and each document to be sent to him,

the coding of the identification information sequences respectively in the form of dot matrixes whose number and position in each matrix indicate the value and position in the sequence of each information unit composing the identification information sequence,

the formatting and customization of the documents for each addressee including the insertion of the identification matrix of the addressee and the document in the portion of the document to be sent back by the addressee,

the transmission by the system of the customized documents to the corresponding addressees,

the receiving by the system of the documents returned by the addressees,

the reading and decoding of the identification matrixes featured on the documents received and the processing of said documents in association with the read and decoded identification data.

The invention more particularly concerns a series of provisions making it possible for firstly carrying out a control of the use of the method by authorized operators using their own computer, and secondly providing a simple means of payment in relation to the extent of this usage.

These results are obtained by attributing to each user an electronic circuit able to be connected to a programmed computer and having available appropriate terminals so as to be able to implement the previously defined method, this electronic circuit including a memory able to be accessed on reading and writing by the computer. This memory could in particular contain information relating to an access code the operator is to transmit to the computer (for example by data entry on a keyboard) so as to be able to implement the method and with a credit allocated to the user, this credit able to correspond to a use time and/or a number of matrix codes the operator is authorized to transmit.

This credit shall automatically be decremented by the computer during each use for example pro rata to the use time and/or the number of edited matrix codes.

Of course, when the credit memorized in the electronic circuit is used up, the computer takes this situation into account and prohibits any subsequent use of the method. Then the operator shall either change the electronic circuit or download the memory so as to obtain a new credit. Of course, these two operations shall give rise to a corresponding payment.

Moreover, the memory of this electronic circuit could contain identification information of the authorized user, this information able to be allocated at the time of purchase of the circuit or even downloaded. This identification information could be coded and inserted in the edited matrices concerning the documents addressed to said addressees. This coding of the identification data of the transmitting entity of the documents, which is only able to be decrypted by the supplier of the software, is able to provide a control so as to know if the documents in circulation have been edited by an unauthorized entity and constitute piratic editings.

It ought to be mentioned that the fact of using an identification information coding is able to firstly code a relatively large amount of information on a reduced surface. This information number could be considerably increased by using multidimensional matrix codes, such as three-dimensional codes. Thus, this coding technique makes it possible for example to code about fifty ASCII codes on a surface measuring 3×3 mm. Secondly, the information to be coded can be previously duplicated and associated with check sums, such as CRC type (“Cyclic Redundancy Check”) sums, which makes it possible during decoding to correct any possible reading errors and thus have the coded identification information with a high level of security. In addition, the information which can be coded by this method can also be binary information, as well as printable characters.

The processing of the documents returned by the addressees may consist of reading the information the latter have supplied.

This information may appear in the form of a questionnaire they received and filled in and comprising boxes to be ticked able to be automatically easily read without the risk of error occurring.

This information may also appear in the form of a reply coupon the addressee may have selected from several reply coupons featured in the sent document. In this case, an identification matrix is associated with each reply coupon, this matrix comprising the identification information of the addressee and the identification information of the coupon.

### BRIEF DESCRIPTION OF THE DRAWINGS

There follows a non-restrictive example of one embodiment of the device of the invention with reference to the accompanying drawings on which:

FIG. 1 diagrammatically shows an installation for implementing the method of the invention,

FIG. 2 shows an application of the method of the invention in the form of a block diagram,

FIG. 3 is a synoptic diagram of the processing carried out in accordance with the method of the invention,

FIG. 4 is a synoptic diagram of the encoding function carried out in accordance with the method of the invention.

### DETAILED DESCRIPTION OF THE PREFERRED EMBODIMENTS

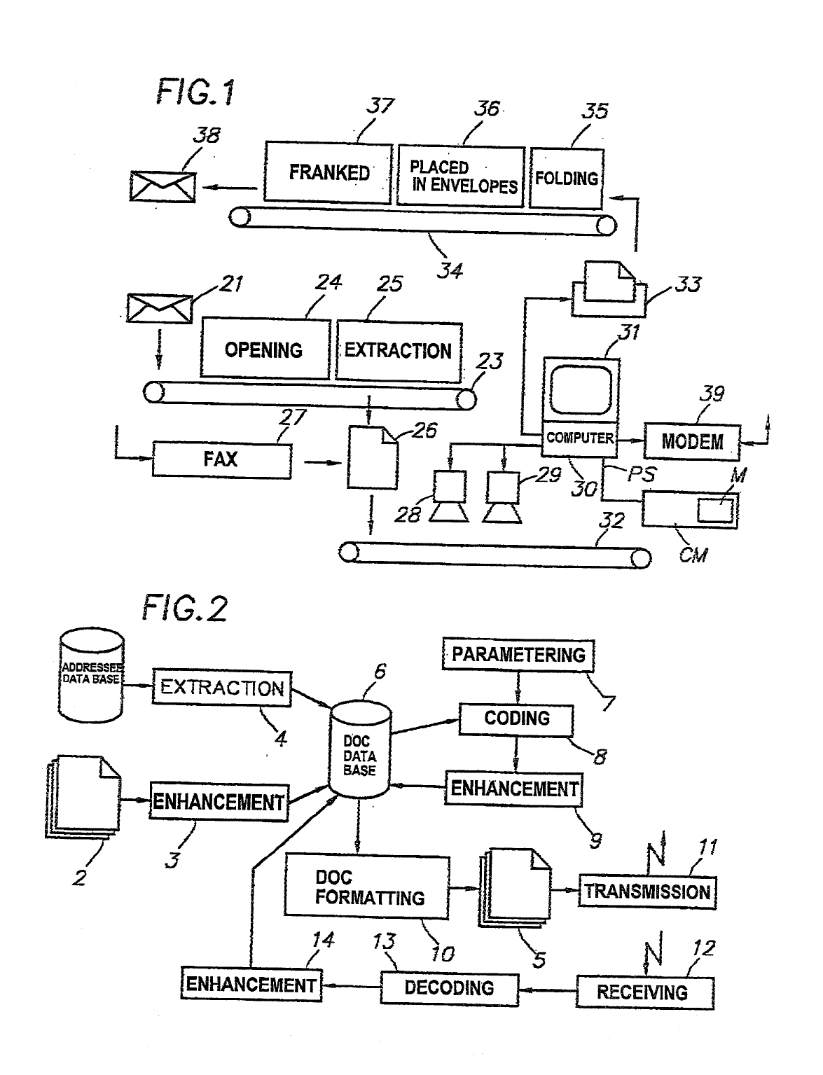

On FIG. 1, the installation for implementing the method of the invention includes a computer 30 comprising a bulk memory in which documents are stored and intended to be sent to a series of addressees, as well as information concerning these persons listed in a data base, this information comprising in particular the identification and addressing information of these persons.

So as to be able to use this method, an electronic circuit CM with a memory M needs to be connected to a computer series port marked PS. The memory M of this electronic circuit CM, accessible on reading and writing by the computer, is intended to contain the identification data of the operator, information relating to an access code the operator needs to transmit to the computer, and data relating to a credit allocated to the user and corresponding to a number of matrix codes the operator is authorized to transmit.

The computer 30 is connected to a display screen 31, a printer 33, a modem 39 for transmitting documents in the form of files or faxes, and optical data acquisition means 28, 29, such as a scanner or video camera. One of these data acquisition means can be specifically designed so as to localize and memorize the matrix codes possibly featured on these documents. To this effect, it could be provided with a magnification optics.

Alternatively, it is possible to use a single optical data acquisition device which merely produces one image per document page.

Furthermore, the printer 31 is coupled to a conveyor 34, such as a belt conveyor, able to carry the documents the printer has printed to a document folding station 35 and then to a station 36 for putting in envelopes the folded documents, and finally to an envelope franking station 37. The envelopes 38, once filled and franked, are then ready to be sent via the post.

The optical data acquisition means 28, 29 are fed by a second conveyor 32 on which the printed documents 26 to be read are placed and can be designed so as to read the front and back of the documents. Alternatively, it is possible to have the documents pass twice opposite the optical data acquisition means and traverse a return station between these two passages.

The printed documents 26 are brought onto the conveyor 32, for example by a third conveyor 23 which receives the documents in an envelope 21 sent by the addressees and brings them successively to a station 24 for opening the envelopes and an extraction station 25 where the envelopes are extracted and unfolded before being placed on the conveyor 32.

The printed documents 26 may also come from a fax 27. In this case, they are placed directly on the conveyor 32.

FIG. 2 shows the method used by the installation shown on FIG. 1 and in particular the various operations carried out by the computer 30. First of all, this method includes an extraction stage 4 for the computer 30 to extract the data required for the transmission of documents, such as a questionnaire, to the addressees identified in the data base 1, the extracted data being arranged in a data base 6 specifically used for the documents to be sent, this data comprising at least the addressing and identification data of the addressee. The data base 6 is moreover enriched in stage 3 by associating each addressee with the identification information of each document to be sent to said addressee, and possibly each reply coupon featured in each of these documents, this identification information being constituted for example by a reference code concerning these documents or reply coupons.

The method of the invention also includes a state 8 for coding the identification information of each addressee in association with the identification data of the documents intended for them, this stage being preceded by a stage 7 for parametering coding.

An information coding methods is used consisting of representing each information unit, such as each octet, of an information sequence in the form of points distributed in a matrix of several lines and columns, the number and position of these points making it possible to recreate the sequence of coded information. Codings of this type authorize redundancies and are able to integrate check sums making it possible to obtain considerable security in the transmission of information in this form.

The parametering stage 7 consists of introducing into the computer 30 all the parameters defining the type of coding used. These parameters include for example redundancy and security rates, the size of a point of the matrix, the proportions of the matrix (width/length ratio). These parameters may also include the size of the matrix (number of lines and columns) if it is desired that the surface occupied by the matrix be independent of the number of information units (octets) in the sequence to be coded.

It is also possible to select the coding principle to be used, that is the type of algorithm providing the position of the points in the matrix according to the value and position of each octet in the sequence to be coded.

Advantageously, the coded data is the data needed to read so as to process the responses of the addressees. Thus, this data includes the identification data of the addressee, such as his/her name and address and the reference code of the document or the reply coupon when the document comprises several of these.

The matrix codes generated in the coding stage 8 are introduced in stage 9 into the data base 6 in association with the corresponding addressees.

This is followed by a document formatting stage 10 consisting of creating at least one customized document 5 for each addressee on the basis of the data stored in the data base 6, this document including the identification and addressing information of the addressee, as well as the matrix code(s) corresponding to the addressee and the document obtained in the coding stage 8. These customized documents are then transmitted to their respective addressees in stage 11.

All known transmission means are useable. Thus, as previously mentioned, the documents 5 can be sent to their addresses by mail, fax or even by an electronic messaging system. It is also possible to select one of these transmission means according to the available addresses of the addressee (postal address, fax number, E-Mail address, . . . ) stored in the data base 6.

When these documents are sent by mail, they are first of all printed by the printer 33, then folded and put into envelopes automatically, as shown on FIG. 1.

The computer 30 can also directly transmit these documents using the modem 39.

The documents returned by the addressees are also automatically processed, as shown on FIG. 1. In stage 12, they are received by the various available transmission means (post, fax 27, modem 39).

As previously mentioned, the printed documents received are optically entered, the matrix codes featured on these documents being read separately or collectively. In addition, the documents transmitted by electronic messaging arrive in the form of data processing files incorporating the matrix codes stored in graphic files.

The images transmitted by the optical data entry means 28, 29 are introduced into the computer 30 so as to be processed and decoded in stage 13.

If appropriate, this processing consists of localizing the locations where the matrix codes are situated which have been introduced during the stage 10 for formatting the documents 5, and of decoding these matrices so as to reconstruct the information derived from coding.

It is to be noted that when documents are transmitted by electronic messaging, only one decoding of the matrix codes is required since the latter are already localized in graphic files sent back by the addressee.

This processing may advantageously be completed by the identification of the boxes ticked by the addressee if the portion of the documents returned comprises a questionnaire in association with boxes to be ticked.

In the next stage 14, all the information received and decoded enrich the data base 6.

Of course, the documents which were unable to be transmitted in stage 11 or did not reach their addressees are processed similarly after having been sorted from other received documents so as to complete and update the information contained in the data base 6. This occurs for example when the address of the addressee used is not correct.

To this effect, when the document is sent by mail, it is possible to use window envelopes and print the name and address of the addressee, as well as the identification matrix code on the document at a position so that this information is visible through the window when the document is put in the envelope. In this way, the non-distributed mail returned by the post authorities can be processed without opening the envelope.

The computer then updates the data base 6 by indicating for all the addressees who have not received a certain document bearing a certain reference, that the latter has not been received and that the address used is incorrect.

The computer 30 then can use another means of communication if the address or corresponding number is available in the data base 6 so as to make try again to transmit the document to the addressee in question.

Do Thus, at the end of stage 14, the data base 6 comprises one registration per addressee including:

the addressing and identification data of the addressee,

the reference codes of the documents sent to this addressee,

the corresponding matrix codes generated in stage 8,

the information returned in the subsequent replies, and

an indication of any possible addressing errors.

The information concerning each addressee recorded in the data base 6 are thus enriched and updated automatically with the aid of the replies received.

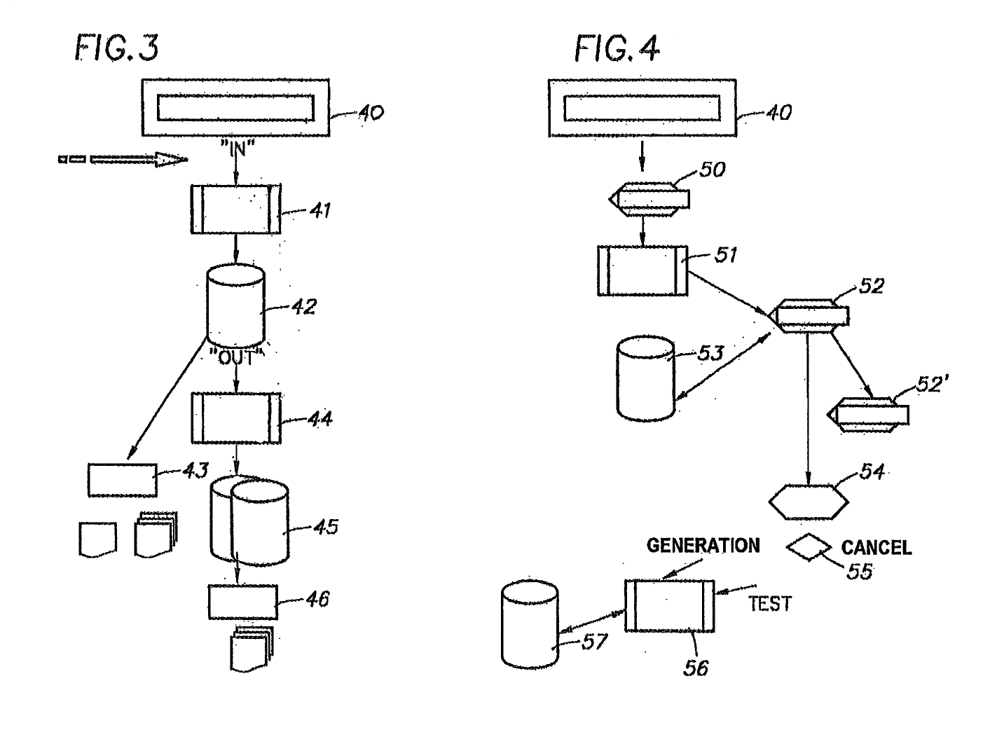

More specifically, so as to edit the matrix codes from information entered on the keyboard or already contained in the computer memories, said computer shall carry out the operational sequence shown on FIG. 3 which successively includes:

the taking into account of an order for executing the general program for encoding and editing the matrix codes (block 40),

the launching of the encoding and check function shown on FIG. 4 which makers it possible to generate the codes (block 41) and storing the corresponding data in a memory of the computer (block 42),

the subsequent transfer of this data into a “large data processing system (block 43) and/or the launching of a conversion function (block 44) which interprets the previously stored data so as to translate it by using a policy of specific characters of the matrix coding and able to be exploited by a conventional word processing software such as “Word”,

the storing and formatting of this interpreted data in a data base 45 directly accessible by the word processing software,

the printing of the matrix codes by the printer associated with the computer under the control of the word processing software (block 46).

On launching of the encoding and control function (40) shown on FIG. 4, the operator has available aid on line and an autotest (block 50) making it possible to display 31 on the screen of the computer 30 the amount of the credit allocated to the user, as well as the identity of said user. As previously mentioned, the encoding function includes the coding (block 51) of the identification information of each addressee in association with the identification data of the documents intended for them, as well as a stage (block 52) for parametering coding consisting of introducing all the parameters defining the type of codings used and whose related data is stored in a data base (block 53).

Advantageously, the operator could choose from several types of codes (such as six different codes), the first code able for example to be possibly allocated in the name of the company, the second to the address, etc.

For each of these codes, the operator shall indicate the length and position of the fields which should contain the information to be edited.

Before the system (block 52′) taking into account parametering, the data relating to a matrix code it is desired to generate is displayed and shall be validated (block 54) with the possibility of cancellation (test 55). When this data is validated, the system generates a matrix code (block 56) and checks and updates the credit allocated to the user by decrementing its amount to each generated code and by again checking that nothing opposes this generation.

At the same time, the system stores the data relating to encoding statistics (block 57).

Advantageously, the files relating to the encoded data could be merged with files of the word processing software so as to enable the user to simultaneously display the codes and their translation on the screen 31 of the computer 30.

What is claimed is:

1. Method for checking the use of a system for transmitting information in the form of multidimensional matrix codes, said system using a computer linked to a data base containing identification and addressing data of addressees and programmed so as to carry out the following operations:
for each addressee, the setting up of an identification information sequence including the identification data of the addressee and each document to be sent to it,
the coding of the identification information sequences respectively in the form of dot matrixes whose number and position in each matrix indicate the value and position in the sequence of each information unit composing the identification information sequence,
the formatting and customization of the documents for each addressee including the insertion of the identification matrix of the addressee and the document in the portion of the document to be sent back by the addressee,
the transmission by the system of the customized documents to the corresponding addressees,
the receiving by the system of the documents returned by the addressees,
the reading and decoding of the identification matrixes featured on the documents received and the processing of said documents in association with the read and decoded identification data,
wherein it consists of allocating to each user an electronic circuit able to be connected to the computer and including a memory able to be accessed on reading and writing by said computer, said memory containing information relating to an access code the operator is to transmit to the computer so as to be able to use the method and to a credit allocated to the user, this credit being automatically decremented by the computer at the time of each use according to the parameters relating to this use.

2. Method according to claim 1, wherein said parameter consists of the number of edited matrix codes.

3. Method according to claim 1, wherein said computer includes means for taking into account the using up of the credit contained in said memory and, on the basis of this taking into account, prohibiting any subsequent use of the method.

4. Method according to claim 3, wherein the credit contained in said memory can be downloaded.

5. Method according to claim 1, wherein said memory contains identification information of the authorized user, this information being allocated at the moment of purchasing the circuit or even downloaded.

6. Method according to claim 5, wherein said identification information is coded and inserted in the edited matrixes on said documents.

7. Method according to claim 1, wherein said electronic circuit is connected to a marked series port of the computer.

8. Method according to claim 1, wherein the identification information sequences to be coded contain duplicated identification information associated with at least one check sum.

9. Method according to claim 1, wherein the processing of document portions received include the reading and storage of information featured in these document portions in association with the read and decoded identification data.

10. Method according to claim 1, wherein the document portions transmitted by the addressees include boxes to be ticked, the method further including the identification of the boxes ticked and not ticked by the addressee.

11. Method according to claim 1, wherein the coded information sequence coded in the form of dot matrixes and fixed on a document contains the identification information of the document.

12. Method according to claim 1, wherein the document sent to each addressee includes several portions, the method including the insertion in each document portion of an identification matrix obtained by the coding of an identification information sequence of the addressee, the document and the document portion.

13. Method according to claim 1, wherein the documents are sent by mail from the processing system to the addressees.

14. Method according to claim 1, wherein the documents are sent by fax from the processing system to the addressees.

15. Method according to claim 1, wherein the documents are sent by electronic messaging from the processing system to the addressees.

16. Method according to claim 1, wherein it further includes a stage for parametering the matrix code including the introduction of the type of matrix coding to be used, a security and redundancy ratio, the size of the points of the matrix, the proportions of the matrix and possibly the size of the matrix.

17. Method according to claim 1, wherein it liner includes the updating of the data base with the information provided in the document portions transmitted by the addressees by indicating if appropriate the addressees who have not received the document sent to them because the address used in erroneous.

18. Method according to claim 17, wherein it further includes the retransmitting of customized documents to the addressees whose address has been used for the first transmission is incorrect by using other transmission means when the address corresponding to these means is available.

19. Method according to claim 1, wherein said matrix codes are three-dimensional.
